(19) United States
(12) Patent Application Publication
(10) Pub. No.: US 2025/0390884 A1
(43) Pub. Date: Dec. 25, 2025

(54) SYSTEMS AND METHODS FOR DYNAMIC DATA GENERATION AND CRYPTOGRAPHIC CARD AUTHENTICATION

(71) Applicant: Capital One Services, LLC, McLean, VA (US)

(72) Inventors: Srinivasa CHIGURUPATI, Long Grove, IL (US); Kevin OSBORN, Newton Highlands, MA (US)

(21) Appl. No.: 19/256,697

(22) Filed: Jul. 1, 2025

Related U.S. Application Data
(63) Continuation of application No. 17/890,077, filed on Aug. 17, 2022.

(51) Int. Cl. G06Q 20/40; G06Q 20/38

(52) U.S. Cl. CPC G06Q 20/4018; G06Q 20/3829; G06Q 20/405

(57) ABSTRACT

Systems and methods for authentication may include an authentication system. The authentication system may include a processor and a memory. The memory may contain a unique identifier, a counter, a session key, and a PAN sequence number. The processor may be configured to receive an authentication request. The processor may be configured to generate, in response to the authentication request, a virtual card number and a dynamic security code based on mapping with a plurality of parameters of a cryptogram including at least one selected from the group of the unique identifier, the counter, the session key, and the PAN sequence number. The processor may be configured to transmit the virtual card number and the dynamic security code to complete the authentication request.

### CROSS-REFERENCE TO RELATED APPLICATION

This application is a continuation of U.S. patent application Ser. No. 17/890,077, filed Aug. 17, 2022, the disclosure of which is incorporated herein by reference in its entirety.

### FIELD OF THE DISCLOSURE

The present disclosure relates to systems and methods for dynamic data generation and cryptographic card authentication.

### BACKGROUND

Electronic and card-based transactions are becoming increasingly common. These transactions often involve the use of a card in communication with a point of sale device, a server, or other device. It is necessary to protect such communications from interception and unauthorized access. Virtual card numbers may offer a way for users for users to use an account without exposing an underlying account number.

Presently, virtual card numbers that are generated are static in nature, thereby creating exposure to malicious actors. For example, malicious actors seeking unauthorized account access and to misuse account information may perform brute force attacks against static virtual card numbers, which leads to security vulnerabilities.

Further, the transmission of data without encryption or other protection is susceptible to malicious attacks, data interception, and may have other vulnerabilities, resulting in increased security risks and increased risks of account or card misuse. These risks may be further increased through the use of contactless cards, which communicate with other devices wirelessly.

Measures taken to address security risk may consume system resources and hinder operational efficiency. For large numbers of transactions, the consumption of system resources and the hindrance of transaction efficiency can increase, which may result in a failure to perform transactions or unsatisfactory performance.

These and other deficiencies exist. Accordingly, there is a need to securely and dynamically generate data and to cryptographically perform card authentication.

### SUMMARY OF THE DISCLOSURE

Embodiments of the present disclosure provide an authentication system. The authentication system may include a processor and a memory. The memory may contain a unique identifier, a counter, a session key, and a primary account number (PAN) sequence number. The processor may be configured to receive an authentication request. The processor may be configured to generate, in response to the authentication request, a virtual card number and a dynamic security code based on mapping with a plurality of parameters of a cryptogram including at least one selected from the group of the unique identifier, the counter, the session key, and the PAN sequence number. The processor may be configured to transmit the virtual card number and the dynamic security code to complete the authentication request

Embodiments of the present disclosure provide a method of authentication. The method may include receiving an authentication request. The method may include generating, by the processor in response to the authentication request, a virtual card number and a dynamic security code based on mapping with a plurality of parameters of a cryptogram including at least one selected from the group of a unique identifier, a counter, a session key, and a PAN sequence number. The method may include transmitting, by the processor, the virtual card number and the dynamic security code to complete the authentication request.

Embodiments of the present disclosure provide a computer accessible non-transitory medium comprising computer executable instructions that, when executed on a processor, perform procedures comprising the steps of: receiving an authentication request; generating, in response to the authentication request, a virtual card number and a dynamic security code based on mapping with a plurality of parameters of a cryptogram including at least one selected from the group of a unique identifier, a counter, a session key, and a PAN sequence number; and transmitting the virtual card number and the dynamic security code to complete the authentication request.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts an authentication system according to an exemplary embodiment.

FIG. 2A is an illustration of a first device according to an exemplary embodiment.

FIG. 2B is an illustration of a contact pad of a first device according to an exemplary embodiment.

FIG. 3 depicts a method of authentication according to an exemplary embodiment.

FIG. 4A depicts a sequence diagram of a process for authentication according to an exemplary embodiment.

FIG. 4B depicts a sequence diagram of a process for authentication according to an exemplary embodiment.

FIG. 4C depicts a sequence diagram of a process for authentication according to an exemplary embodiment.

FIG. 5 depicts a method of authentication according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Systems and methods disclosed herein enable provisioning and usage of a dynamic card verification value for a generated virtual card number. Such an implementation provides controlled utilization of these parameters and may be only be refreshed upon physical possession of the card. By doing so, security vulnerabilities associated with virtual card numbers may be reduced. For example, the risk of brute force attacks and also fraud in card-not-present transactions, including but not limited to security verification transactions, authorization access transactions, and other non-ecommerce transactions, may be reduced.

In addition, the systems and methods disclosed herein allow for the avoidance of phishing attacks, the prevention of replay attacks, and the unauthorized interception of data through encrypted data communications. Accordingly the risk of these vulnerabilities, and others, may be reduced.

The systems and methods disclosed facilitate the performance of transactions, promotes transactional efficiency, and efficiently uses system resources. These benefits become increasingly important as the volume of transactions increases.

Further, the systems and methods disclosed herein achieve these benefits without degrading the user experience. By promoting the user experience, users will be more likely to engage in more secure transactions.

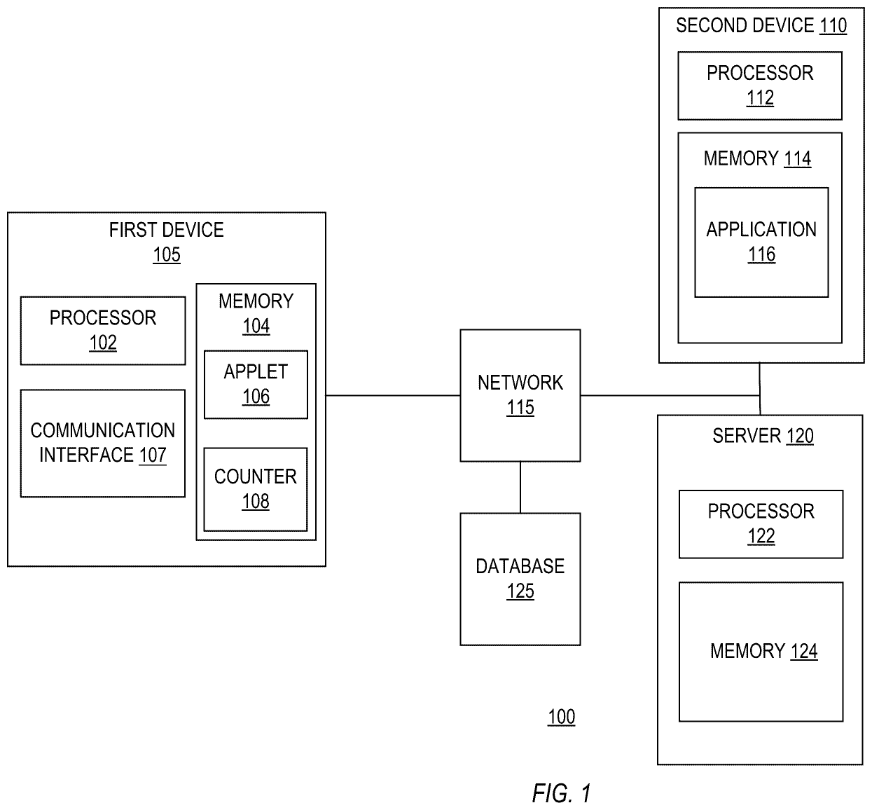

FIG. 1 illustrates an authentication system 100. The system 100 may comprise a first device 105, a second device 110, a network 115, a server 120, and a database 125. Although FIG. 1 illustrates single instances of components of system 100, system 100 may include any number of components.

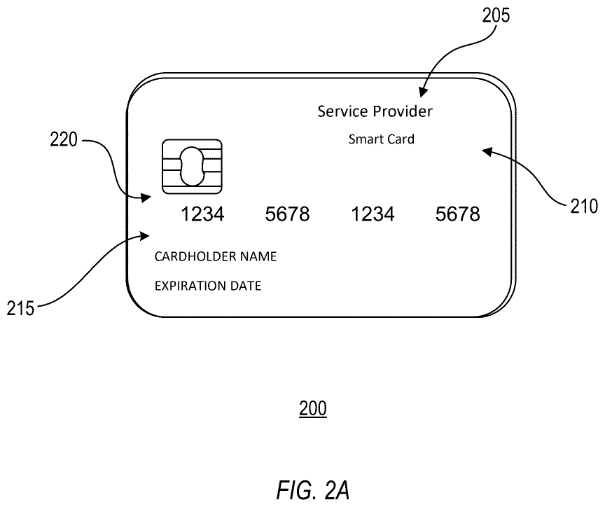

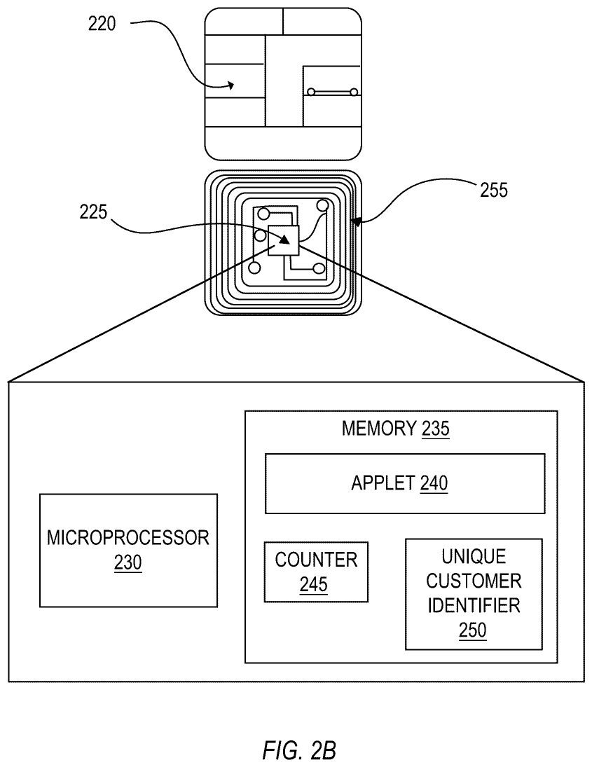

System 100 may include a first device 105. The first device 105 may comprise a contactless card, a contact-based card, a network-enabled computer, or other device described herein. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, a mobile device, a wearable device, a client device, or other device. As further explained below in FIGS. 2A-2B, first device 105 may include one or more processors 102, and memory 104. Memory 104 may include one or more applets 106 and one or more counters 108. Each counter 108 may include a counter value. Memory 104 may include the counter value, transmission data, a unique identifier, an applet version number, a sequence number, and a plurality of keys.

First device 105 may include a communication interface 107. The communication interface 107 may comprise communication capabilities with physical interfaces and contactless interfaces. For example, the communication interface 107 may be configured to communicate with a physical interface, such as by swiping through a card swipe interface or inserting into a card chip reader found on an automated teller machine (ATM) or other device configured to communicate over a physical interface. In other examples, the communication interface 107 may be configured to establish contactless communication with a card reading device via a short-range wireless communication method, such as near field communication (NFC), Bluetooth, Wi-Fi, Radio Frequency Identification (RFID), and other forms of contactless communication. As shown in FIG. 1, the communication interface 107 may be configured to communicate directly with the second device 110, server 120, and/or database 125 via network 115.

First device 105 may be in data communication with any number of components of system 100. For example, first device 105 may transmit data via network 115 to second device 110, and/or server 120. First device 105 may transmit data via network 115 to database 125. In some examples, first device 105 may be configured to transmit data via network 115 after entry into one or more communication fields of any device. Without limitation, each entry may be associated with a tap, a swipe, a wave, and/or any combination thereof.

System 100 may include a second device 110. The second device 110 may include one or more processors 112, and memory 114. Memory 114 may be a transitory and/or non-transitory memory and may include one or more applications, including but not limited to application 116. Second device 110 may be in data communication with any number of components of system 100. For example, second device 110 may transmit data via network 115 to server 120. Second device 110 may transmit data via network 115 to database 125. Without limitation, second device 110 may be a network-enabled computer. Second device 110 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 110 may include processing circuitry and may contain additional components, including processors, memories, error and parity/CRC checkers, data encoders, anticollision algorithms, controllers, command decoders, security primitives and tamperproofing hardware, as necessary to perform the functions described herein. The second device 110 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include a network 115. In some examples, network 115 may be one or more of a wireless network, a wired network or any combination of wireless network and wired network, and may be configured to connect to any one of components of system 100. For example, first device 105 may be configured to connect to server 120 via network 115. In some examples, network 115 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, RFID, Wi-Fi, and/or the like.

In addition, network 115 may include, without limitation, telephone lines, fiber optics, IEEE Ethernet 902.3, a wide area network, a wireless personal area network, a LAN, or a global network such as the Internet. In addition, network 115 may support an Internet network, a wireless communication network, a cellular network, or the like, or any combination thereof. Network 115 may further include one network, or any number of the exemplary types of networks mentioned above, operating as a stand-alone network or in cooperation with each other. Network 115 may utilize one or more protocols of one or more network elements to which they are communicatively coupled. Network 115 may translate to or from other protocols to one or more protocols of network devices. Although network 115 is depicted as a single network, it should be appreciated that according to one or more examples, network 115 may comprise a plurality of interconnected networks, such as, for example, the Internet, a service provider's network, a cable television network, corporate networks, such as credit card association networks, and home networks.

System 100 may include one or more servers 120. In some examples, server 120 may include one or more processors 122 coupled to memory 124. Server 120 may be configured as a central system, server or platform to control and call various data at different times to execute a plurality of workflow actions. Server 120 may be configured to connect to first device 105. Server 120 may be in data communication with the applet 106 and/or application 116. For example, a server 120 may be in data communication with applet 106 via one or more networks 115. First device 105 may be in communication with one or more servers 120 via one or more networks 115, and may operate as a respective front-end to back-end pair with server 120. First device 105 may transmit, for example from applet 106 executing thereon, one or more requests to server 120. The one or more requests may be associated with retrieving data from server 120. Server 120 may receive the one or more requests from first device 105. Based on the one or more requests from applet 106, server 120 may be configured to retrieve the requested data. Server 120 may be configured to transmit the received data to applet 106, the received data being responsive to one or more requests.

In some examples, server 120 can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server 120, it is understood that other embodiments can use multiple servers or multiple computer systems as necessary or desired to support the users and can also use back-up or redundant servers to prevent network downtime in the event of a failure of a particular server.

Server 120 may include an application comprising instructions for execution thereon. For example, the application may comprise instructions for execution on the server 120. The application of the server 120 may be in communication with any components of system 100. For example, server 120 may execute one or more applications that enable, for example, network and/or data communications with one or more components of system 100 and transmit and/or receive data. Without limitation, server 120 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. Server 120 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include processing circuitry and may contain additional components, including processors, memories, error and parity/CRC checkers, data encoders, anticollision algorithms, controllers, command decoders, security primitives and tamperproofing hardware, as necessary to perform the functions described herein. The server 120 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include one or more databases 125. The database 125 may comprise a relational database, a non-relational database, or other database implementations, and any combination thereof, including a plurality of relational databases and non-relational databases. In some examples, the database 125 may comprise a desktop database, a mobile database, or an in-memory database. Further, the database 125 may be hosted internally by any component of system 100, such as the first device 105 or server 120, or the database 125 may be hosted externally to any component of the system 100, such as the first device 105 or server 120, by a cloud-based platform, or in any storage device that is in data communication with the first device 105 and server 120. In some examples, database 125 may be in data communication with any number of components of system 100. For example, server 120 may be configured to retrieve the requested data from the database 125 that is transmitted by applet 106. Server 120 may be configured to transmit the received data from database 125 to applet 106 via network 115, the received data being responsive to the transmitted one or more requests. In other examples, applet 106 may be configured to transmit one or more requests for the requested data from database 125 via network 115.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the first device 105, second device 110, server 120, and/or database 125, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

The processor 102 may be configured to receive an authentication request. In some examples, the processor 102 may be configured to receive an authentication request from any device, including but not limited to a client device 110. In other examples, the application 116 of the client device 110 may be configured to receive the authentication request from processor 122 of server 120. The application 116 of the client device 110 may be configured to conduct one or more reads of the first device 105, such as the card. For example, the application 116 may be configured to conduct a read, such as a near field communication read, of a tag of the first device 105. In some examples, the application 116 may be configured to read information including a unique identification number associated with the first device, a counter (e.g. a counter associated with a number of reads of the first device, a counter associated with the number of transactions involving the first device, an application transaction counter), or a shared secret. In some examples, the application 116 can be configured to read a cryptogram generated using one or more cryptographic algorithms. The cryptogram can be dynamically generated as described herein in response to the authentication request. In some examples, the shared secret can be a number that is known or derived by the server 120 and/or the client device 110 and stored on the first device 105. The shared secret can be included in cryptographic calculations (e.g., used in cryptographic operations and by cryptographic algorithms) but is not transmitted between any of the devices.

The processor 102 may be configured to generate, in response to the authentication request, a virtual card number and a dynamic security code based on mapping with a plurality of parameters of a cryptogram including at least one selected from the group of the unique identifier, the counter, the session key, and the primary account number (PAN) sequence number. In some examples, an initial value of the virtual card number is zero. Without limitation, the virtual card number may include a total of up to 16 digits. Also without limitation, the dynamic security code may comprise a card verification value. For example, the card verification value may comprise a total of up to 3 digits. In other examples, an initial value of the virtual card number is non-zero.

The processor 102 may be configured to transmit, after entry into one or more communication fields of any device, including but not limited to second device 110, data responsive to the read, such as a first read. For example, the processor 102 may be configured to transmit, after a first entry into a first communication field of a second device 110, the cryptogram. Without limitation, each entry may be associated with a tap, a swipe, a wave, and/or any combination thereof. The cryptogram may be received, upon request, via a near field communication data exchange format (NDEF) read. The processor 102 may be configured to transmit the cryptogram. In some examples, the processor 102 may be configured to encrypt the first cryptogram prior to its transmission. For example, the processor 102 may be configured to generate a plurality of session keys, such as a first session key and a second session key, using secret keys combined with the counter. A message authentication code (MAC) may be generated with the first session key. The MAC may be encrypted with the second session key prior to its transmission for decryption and validation. The processor 122 of server 120 may be configured to generate unique derived keys using the unique identifier and master keys. The processor of server 120 may be configured to generate session keys from the unique derived keys and the counter. The processor 122 of server 120 may be configured to decrypt the encrypted MAC from the cryptogram. The processor 122 of server 120 may be configured to validate the MAC using the session key.

The processor 102 may be configured to transmit the cryptogram via the communication interface 107. For example, the processor 102 may be configured to transmit the cryptogram to one or more applications, such as application 116. In some examples, the processor 102 may be configured to transmit the cryptogram to an application 116 comprising instructions for execution on a second device 110. The processor 102 may be configured to update the counter value after transmission of the cryptogram.

In some examples, the processor 122 of server 120 may be configured to receive the cryptogram transmitted by the processor 112 that was transmitted by processor 102. The application 116 of the client device 110 may be configured to transmit the cryptogram by the processor 102 to the processor 122 server 120. The processor 122 of server 120 may be configured to decrypt the cryptogram.

The processor 102 may be further configured to restrict the virtual card number to a limited use. In other examples, it is understood that processor 122 of server 120 may be configured to perform any number of operations performed by processor 102 of first device 105. For example, the processor 102 may be configured to limited the virtual card to a single use or any number of uses not to exceed a threshold number. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

In some examples, the processor 102 may be configured to select, via one or more cryptographic algorithms, one or more digits of the cryptogram to generate the virtual card number. For example, the processor 102 may be configured to select the first digit of the cryptogram. In another example, the processor 102 may be configured to select the last digit of the cryptogram. In another example, the processor 102 may be configured to select any number(s) and/or any sequence of number(s) between the first digit and the last digit of the cryptogram. In another example, the processor 102 may be configured to select any combination of digits of the cryptogram.

In some examples, the processor 122 of server 120 may be configured to select one or more digits of the cryptogram to generate the virtual card number. In some examples, a sequence of numbers may be selected. The processor 122 may be configured to generate the virtual card number after a successful validation of the cryptogram and/or customer data (e.g., a customer identifier, transaction data). The processor 122 may be configured to transmit the virtual card number to the first device 105.

In some examples, the processor 102 of the first device 105 may be configured to select a sequence of one or more numbers between the first digit and the last digit of the cryptogram. In such examples, the processor 122 of server 120 may be configured to maintain a bitmap to define the sequence order used during dynamic virtual card number generation and validation. The bitmap may be maintained at the virtual card number system level or at the record level.

In some examples, the processor 102 may be further configured to restrict the virtual card number to a time window. For example, the processor 102 may be configured to limit the use of the virtual card number to between a time window range including a first value and a second value. In some examples, the processor 102 may be configured to restrict the dynamic security code for utilization in a time window. Further, the processor 102 may be configured to invalidate the dynamic security code if not utilized within the time window. Without limitation, the time window range may include any number of seconds, minutes, hours, days, weeks, months, years, or the like.

Accordingly, when a user is prompted to input, including but not limited to via a application 116 of second device 110 for providing information to a website to process a transaction, the virtual card number and dynamic security code, the processor 102 of first device 105 may enter the communication field of the device to transmit this information with the cryptogram to the device. In this manner, the application 116 of the second device 110 may be configured to transmit the cryptogram including the counter to the processor 122 of server 120. The processor 122 of server 120 may be configured to permit the dynamic security code and virtual card number for the designated time window until the counter is adjusted. Thus, this implementation enables restricted use of the virtual card number and that requires the physical card itself and the dynamic security code.

Further, the processor 102 may be further configured to synchronize the counter with the server during the time window. For example, the processor 102 may be configured to adjust the counter. In some examples, the processor 102 may be configured to increment the counter with the virtual card number and the dynamic security code during the time window. In other examples, the processor 102 may be configured to decrement the counter with the virtual card number and the dynamic security code during the time window. The increment and/or decrement may be determined by the processor 102 according to a sequence. For example, the processor 102 may be configured to increment the counter by even numbers, odd numbers, or a formula so as to provide increased security and prevent the likelihood of brute force attacks. For example, the processor 102 may be configured to decrement the counter by even numbers, odd numbers, or a formula so as to provide increased security and prevent the likelihood of brute force attacks. It is further understood that the sequence may be selected by the processor so as to avoid increased processing load on the first device 105. In this manner, the one or more cryptographic algorithms may be configured to create a sufficiently high entropy number for the dynamic security code that may be reduce the likelihood of brute force attacks. The processor 122 of server 120 may thus be configured to make a note of the adjustment of the counter of the card, such as an increment or a decrement, so as to associate it with the dynamic security code and virtual card number and also avoid asynchronization with the first device 105. Absent the entry by the processor 102 of first device 105 into the communication field of second device 110, such as the aforementioned tap, swipe, or wave, the dynamic security code and virtual card number generated by the card will not be able to be transmitted, and therefore result in non-compliance of the authentication request.

The dynamic generation of the security code is possible only after the successful validation of cryptogram by, e.g., the processor 120 of server 120. Further, integration with the application 116 of second device 110 may also be required prior to the generation of the security code.

The processor 102 may be further configured to encrypt the virtual card number and the dynamic security code using a session key, such as a session key generated as described herein. After successful validation of the cryptogram and/or customer data, the mobile application 116 may be configured to display the virtual card number and the dynamic security code. A successful validation may be required prior to the display, and/or prior to the use of, the virtual card number and the dynamic security code. Display and/or use of the virtual card number and the dynamic security code may be limited to authorized applications and devices, such as application 116 and server 120. Decryption of the virtual card number and the dynamic security code may be controlled by the hardware security module and/or the managed and integrated application programming interface of the second device 110 and the server 120.

The processor 102 may be configured to transmit the virtual card number and the dynamic security code to complete the authentication request. For example, the processor 102 may be configured to transmit, in response to a scan of a quick response (QR) code, the virtual card number and the dynamic security code. In some examples, the processor 102 may be configured to transmit the virtual card number and the dynamic security code via a notification. Without limitation, the notification may include at least one selected from the group of a pop-up notification, a short message service, and a QR code. The notification may be displayed by the application 116 of the second device 110.

In some examples, the processor 102 may be further configured to encrypt the virtual card number and the dynamic security code prior to transmission. The processor 102 may be configured to perform the encryption using a session key, such as a session key generated as described herein. Display and/or use of the virtual card number and the dynamic security code can be permitted only after successful validation of the cryptogram and/or customer data and limited only to authorized applications and devices, such as application 116 and server 120. Decryption of the virtual card number and the dynamic security code may be controlled by the hardware security module and/or the managed and integrated application programming interface of the second device 110 and the server 120.

FIGS. 2A and 2B illustrates one or more first devices 200. First device 200 may reference the same or similar components of first device 105, as explained above with respect to FIG. 1. Although FIGS. 2A and 2B illustrate single instances of components of first device 200, any number of components may be utilized.

First device 200 may be configured to communicate with one or more components of system 100. First device 200 may comprise a contact-based card or contactless card, which may comprise a payment card, such as a credit card, debit card, or gift card, issued by a service provider 205 displayed on the front or back of the contactless card 200. In some examples, the contactless card 200 is not related to a payment card, and may comprise, without limitation, an identification card, a membership card, a point of access card, and a transportation card. The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, including but not limited to a user device, smart phone, laptop, desktop, or tablet computer. The contactless card 200 may also include processing circuitry, antenna and other components not shown in FIG. 2A. These components may be located behind the contact pad 220 or elsewhere on the substrate 210. The contactless card 200 may also include a magnetic strip or tape, which may be located on the back of the card (not shown in FIG. 2A).

As illustrated in FIG. 2B, the contact pad 220 of FIG. 2A may include processing circuitry 225 for storing and processing information, including a processor 230, such as a microprocessor, and a memory 235. It is understood that the processing circuitry 225 may contain additional components, including processors, memories, error and parity/CRC checkers, data encoders, anticollision algorithms, controllers, command decoders, security primitives and tamperproofing hardware, as necessary to perform the functions described herein.

The memory 235 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 235 may be configured to store one or more applets 240, one or more counters 245, and a customer identifier 250. The one or more applets 240 may comprise one or more software applications configured to execute on one or more contactless cards, such as Java Card applet. However, it is understood that applets 240 are not limited to Java Card applets, and instead may be any software application operable on contactless cards or other devices having limited memory. The one or more counters 245 may comprise a numeric counter sufficient to store an integer. The customer identifier 250 may comprise a unique alphanumeric identifier assigned to a user of the contactless card 200, and the identifier may distinguish the user of the contactless card from other contactless card users. In some examples, the customer identifier 250 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the contact pad 220 or entirely separate from it, or as further elements in addition to processor 230 and memory 235 elements located within the contact pad 220.

In some examples, the contactless card 200 may comprise one or more antennas 255. The one or more antennas 255 may be placed within the contactless card 200 and around the processing circuitry 225 of the contact pad 220. For example, the one or more antennas 255 may be integral with the processing circuitry 225 and the one or more antennas 255 may be used with an external booster coil. As another example, the one or more antennas 255 may be external to the contact pad 220 and the processing circuitry 225.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

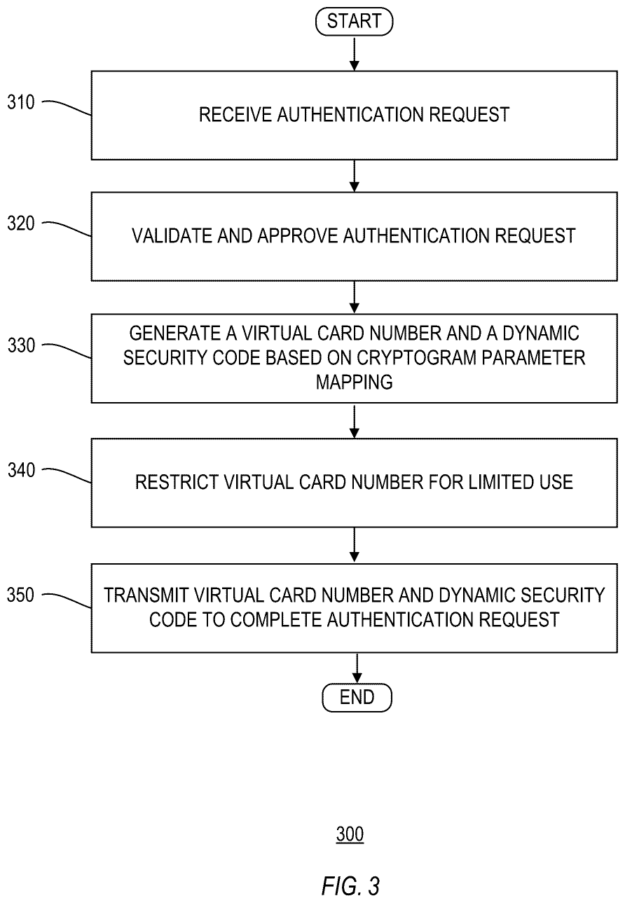

FIG. 3 depicts a method 300 of authentication. FIG. 3 may reference the same or similar components of system 100 and first device 200 of FIG. 2A and FIG. 2B.

At block 310, the method may include receiving, by a processor, an authentication request. The processor may belong to a first device, including but not limited to a card, a server, or a client device. In some examples, the processor may be configured to receive an authentication request from any device, including but not limited to a mobile device.

At block 320, the method may include validating and approving, by the processor, the authentication request. This may be performed by any of the methods described herein.

At block 330, the method 300 may include generating, by the processor in response to the authentication request, a virtual card number and a dynamic security code based on mapping with a plurality of parameters of a cryptogram including at least one selected from the group of a unique identifier, a counter, a session key, and a PAN sequence number. In some examples, an initial value of the virtual card number is zero. Without limitation, the virtual card number may include a total of up to 16 digits. Also without limitation, the dynamic security code may comprise a card verification value. For example, the card verification value may comprise a total of up to 3 digits. In other examples, an initial value of the virtual card number is non-zero.

The processor may be configured to transmit, after entry into one or more communication fields of any device, data responsive to the read, such as a first read. For example, the processor may be configured to transmit, after a first entry into a first communication field of a device, the cryptogram. Without limitation, each entry may be associated with a tap, a swipe, a wave, and/or any combination thereof. The cryptogram may be received, upon request, via a near field communication data exchange format (NDEF) read. The processor may be configured to transmit the cryptogram. In some examples, the processor may be configured to encrypt the first cryptogram prior to its transmission. For example, the processor may be configured to generate a plurality of session keys, such as a first session key and a second session key, using secret keys combined with the counter. The MAC may be generated with the first session key. The MAC may be encrypted with the second session key prior to its transmission for decryption and validation. The server may be configured to generate unique derived keys using the unique identifier and master keys. The server may be configured to generate session keys from the unique derived keys and the counter. The server may be configured to decrypt the encrypted MAC from the cryptogram. The server may be configured to validate the MAC using the session key.

The processor may be configured to transmit the cryptogram via the communication interface. For example, the processor may be configured to transmit the cryptogram to one or more applications. In some examples, the processor may be configured to transmit the cryptogram to an application comprising instructions for execution on a second device. The processor may be configured to update the counter value after transmission of the cryptogram.

In some examples, the server may be configured to receive the cryptogram transmitted by the processor. The application of the client device may be configured to transmit the cryptogram by the processor to the server. The server may be configured to decrypt the cryptogram.

At block 340, the method 300 may include restricting the virtual card number to a limited use. For example, the processor may be configured to limited the virtual card to a single use or any number of uses not to exceed a threshold number. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

In some examples, the processor may be configured to select, via one or more cryptographic algorithms, one or more digits of the cryptogram to generate the virtual card number. For example, the processor may be configured to select the first digit of the cryptogram. In another example, the processor may be configured to select the last digit of the cryptogram. In another example, the processor may be configured to select any number(s) and/or any sequence of number(s) between the first digit and the last digit of the cryptogram. In another example, the processor may be configured to select any combination of digits of the cryptogram.

In some examples, the processor may be further configured to restrict the virtual card number to a time window. For example, the processor may be configured to limit the use of the virtual card number to between a time window range including a first value and a second value. In some examples, the processor may be configured to restrict the dynamic security code for utilization in a time window. Further, the processor may be configured to invalidate the dynamic security code if not utilized within the time window. Without limitation, the time window range may include any number of seconds, minutes, hours, days, weeks, months, years, or the like.

Accordingly, when a user is prompted to input, including but not limited to via a mobile application for providing information to a website to process a transaction, the virtual card number and dynamic security code, the card may enter the communication field of the device to transmit this information with the cryptogram to the device. In this manner, the application of the device may be configured to transmit the cryptogram including the counter to the server. The server may be configured to permit the dynamic security code and virtual card number for the designated time window until the counter is adjusted. Thus, this implementation enables restricted use of the virtual card number and that requires the physical card itself and the dynamic security code.

Further, the processor may be further configured to synchronize the counter with the server during the time window. For example, the processor may be configured to adjust the counter. In some examples, the processor may be configured to increment the counter with the virtual card number and the dynamic security code during the time window. In other examples, the processor may be configured to decrement the counter with the virtual card number and the dynamic security code during the time window. The increment and/or decrement may be determined by the processor according to a sequence. For example, the processor may be configured to increment the counter by even numbers, odd numbers, or a formula so as to provide increased security and prevent the likelihood of brute force attacks. For example, the processor may be configured to decrement the counter by even numbers, odd numbers, or a formula so as to provide increased security and prevent the likelihood of brute force attacks. It is further understood that the sequence may be selected by the processor so as to avoid increased processing load on the card. In this manner, the one or more cryptographic algorithms may be configured to create a sufficiently high entropy number for the dynamic security code that may be reduce the likelihood of brute force attacks. The server may thus be configured to make a note of the adjusted, such as increment or decrement, counter of the card so as to associate it with the dynamic security code and virtual card number and also avoid asynchronization with the card. Absent the entry by the card into the communication field, such as the aforementioned tap, swipe, or wave, the dynamic security code and virtual card number generated by the card will not be able to be transmitted, and therefore result in non-compliance of the authentication request.

At block 350, the method 300 may include transmitting, by the processor, the virtual card number and the dynamic security code to complete the authentication request. For example, the processor may be configured to transmit the virtual card number and the dynamic security code to complete the authentication request. For example, the processor may be configured to transmit, in response to a scan of a QR code, the virtual card number and the dynamic security code. In some examples, the processor may be configured to transmit the virtual card number and the dynamic security code via a notification. Without limitation, the notification may include at least one selected from the group of a pop-up notification, a short message service, and a QR code. The notification may be displayed by the device.

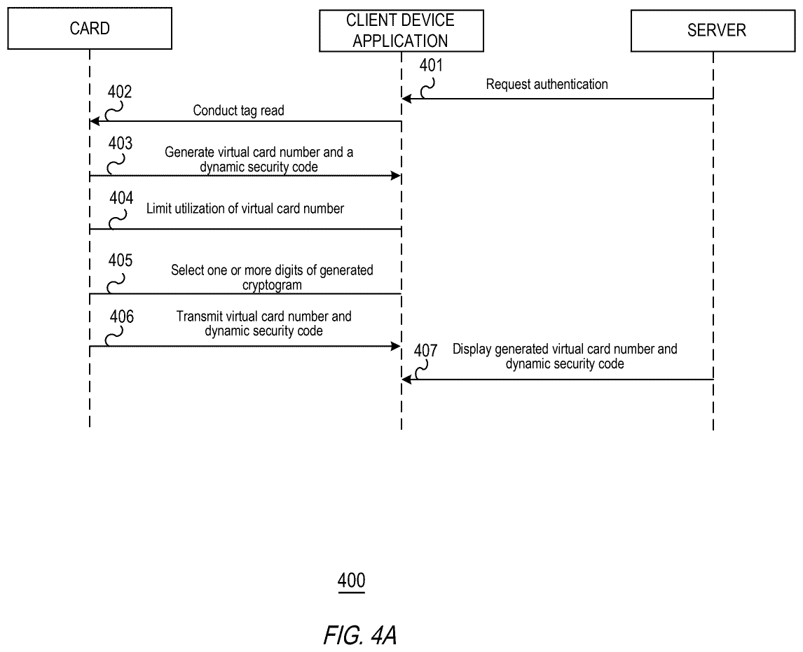

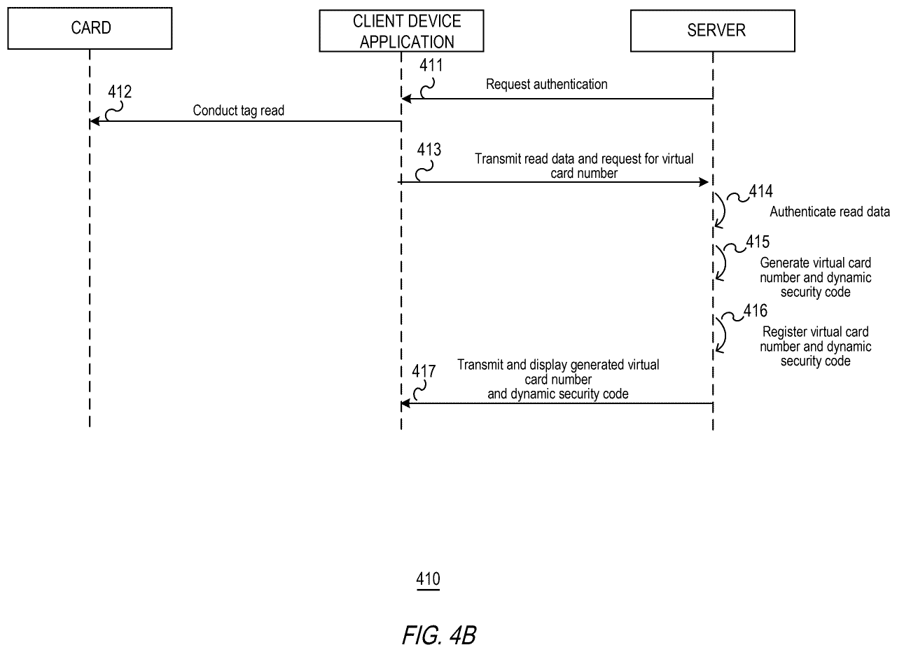

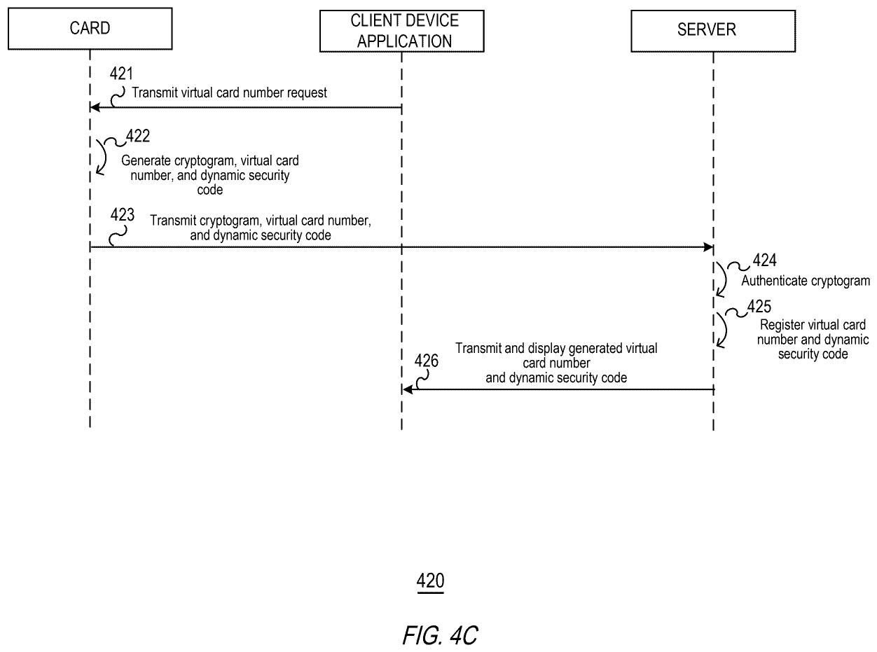

FIG. 4A depicts a sequence diagram 400 of a process for authentication according to an exemplary embodiment. FIG. 4A may reference the same or similar components of system 100, first device 200 of FIG. 2A and FIG. 2B, and method 300 of FIG. 3.

At step 401, a processor may be configured to receive one or more requests. The processor may belong to a first device, including but not limited to a card (or other first device), a server, or a client device, or a combination thereof. In some examples, the processor may be configured to receive an authentication request from any device, including but not limited to a client device. The request may be transmitted from a processor of a server to a processor or application of an intermediary device, such as a client device, which in turn may be configured to transmit the authentication request to the processor of the card.

At step 402, the processor or application of the client device may be configured to conduct one or more reads. For example, the processor or application may be configured to conduct a read, such as a near field communication read, of a tag of the card. Other information that can be read include a unique identification number associated with the card, a counter (e.g. a counter associated with a number of reads of the first device, a counter associated with the number of transactions involving the first device, an application transaction counter), a shared secret, and a cryptogram. In some examples, a cryptogram can be generated by the card that includes the read data, and the cryptogram can be generating using the read data and/or one or more cryptographic algorithms. In some examples, the shared secret can comprise a number that is known or derived by the application and/or server and stored on the card. The shared secret can be used in generating a cryptogram and/or performing cryptographic operations using one or more cryptographic algorithms. In some examples, the processor or application of the client device may be configured to display a notification or otherwise prompt to conduct the read.

At step 403, the processor may be configured to generate a virtual card number and a dynamic security code based on mapping with a plurality of parameters of the read data, including, for example, a cryptogram including at least one selected from the group of a unique identifier, a counter, a session key, and a PAN sequence number. In some examples, an initial value of the virtual card number is zero. Without limitation, the virtual card number may include a total of up to 16 digits. Also without limitation, the dynamic security code may comprise a card verification value. For example, the card verification value may comprise a total of up to 3 digits. In other examples, an initial value of the virtual card number is non-zero.

In other examples, the processor may receive the virtual card number generated by another device, such as a card, a server, or a client device. The virtual card number may be generated based on information received from the card (e.g., a unique identifier, a counter, a shared secret) and upon successful authentication of the received information. In some examples, the shared secret can be a number that is known or derived by the server and/or the client device and stored on the first device. The shared secret can be included in cryptographic calculations (e.g., used in cryptographic operations and by cryptographic algorithms) but is not transmitted between any of the devices.

The virtual card number can be generated with an initial or default security code value, such as a security code of zero. The virtual card number can be maintained in database of virtual card numbers and transmitted to the processor. The virtual card number can be encrypted by, e.g., a session key, prior to transmission. Upon receipt of the virtual card number, the processor can decrypt the virtual card number and generate the dynamic security code.

The processor may be configured to transmit, after entry into one or more communication fields of any device, data responsive to the read, such as a first read. For example, the processor may be configured to transmit, after a first entry into a first communication field of a device, the cryptogram. Without limitation, each entry may be associated with a tap, a swipe, a wave, and/or any combination thereof. The cryptogram may be received, upon request, via a near field communication data exchange format (NDEF) read. The processor may be configured to transmit the cryptogram. In some examples, the processor may be configured to encrypt the first cryptogram prior to its transmission. For example, the processor may be configured to generate a plurality of session keys, such as a first session key and a second session key, using secret keys combined with the counter. The MAC may be generated with the first session key. The MAC may be encrypted with the second session key prior to its transmission for decryption and validation. The server may be configured to generate unique derived keys using the unique identifier and master keys. The server may be configured to generate session keys from the unique derived keys and the counter. The server may be configured to decrypt the encrypted MAC from the cryptogram. The server may be configured to validate the MAC using the session key.

The processor may be configured to transmit the cryptogram via the communication interface. For example, the processor may be configured to transmit the cryptogram to one or more applications. In some examples, the processor may be configured to transmit the cryptogram to an application comprising instructions for execution on a second device. The processor may be configured to update the counter value after transmission of the cryptogram.

In some examples, the server may be configured to receive the cryptogram transmitted by the processor. The application of the client device may be configured to transmit the cryptogram by the processor to the server. The server may be configured to decrypt the cryptogram.

At step 404, the processor may be configured to restrict the virtual card number to a limited use. For example, the processor may be configured to limited the virtual card to a single use or any number of uses not to exceed a threshold number. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

At step 405, the processor may be configured to select, via one or more cryptographic algorithms, one or more digits of the cryptogram to generate the virtual card number. For example, the processor may be configured to select the first digit of the cryptogram. In another example, the processor may be configured to select the last digit of the cryptogram. In another example, the processor may be configured to select any number(s) and/or any sequence of number(s) between the first digit and the last digit of the cryptogram. In another example, the processor may be configured to select any combination of digits of the cryptogram.

In some examples, the processor may be further configured to restrict the virtual card number to a time window. For example, the processor may be configured to limit the use of the virtual card number to between a time window range including a first value and a second value. In some examples, the processor may be configured to restrict the dynamic security code for utilization in a time window. Further, the processor may be configured to invalidate the dynamic security code if not utilized within the time window. Without limitation, the time window range may include any number of seconds, minutes, hours, days, weeks, months, years, or the like. Accordingly, when a user is prompted to input, including but not limited to via a mobile application for providing information to a website to process a transaction, the virtual card number and dynamic security code, the card may enter the communication field of the device to transmit this information with the cryptogram to the device. In this manner, the application of the device may be configured to transmit the cryptogram including the counter to the server. The server may be configured to permit the dynamic security code and virtual card number for the designated time window until the counter is adjusted. Thus, this implementation enables restricted use of the virtual card number and that requires the physical card itself and the dynamic security code. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

Further, the processor may be further configured to synchronize the counter with the server during the time window. For example, the processor may be configured to adjust the counter. In some examples, the processor may be configured to increment the counter with the virtual card number and the dynamic security code during the time window. In other examples, the processor may be configured to decrement the counter with the virtual card number and the dynamic security code during the time window. The increment and/or decrement may be determined by the processor according to a sequence. For example, the processor may be configured to increment the counter by even numbers, odd numbers, or a formula so as to provide increased security and prevent the likelihood of brute force attacks. For example, the processor may be configured to decrement the counter by even numbers, odd numbers, or a formula so as to provide increased security and prevent the likelihood of brute force attacks. It is further understood that the sequence may be selected by the processor so as to avoid increased processing load on the card. In this manner, the one or more cryptographic algorithms may be configured to create a sufficiently high entropy number for the dynamic security code that may be reduce the likelihood of brute force attacks. The server may thus be configured to make a note of the adjusted, such as increment or decrement, counter of the card so as to associate it with the dynamic security code and virtual card number and also avoid asynchronization with the card. Absent the entry by the card into the communication field, such as the aforementioned tap, swipe, or wave, the dynamic security code and virtual card number generated by the card will not be able to be transmitted, and therefore result in non-compliance of the authentication request.

At step 406, the processor may be configured to transmit the virtual card number and the dynamic security code to complete the authentication request. For example, the processor may be configured to transmit, in response to a scan of a QR code, the virtual card number and the dynamic security code. In some examples, the processor may be configured to transmit the virtual card number and the dynamic security code via a notification. Without limitation, the notification may include at least one selected from the group of a pop-up notification, a short message service, and a QR code.

At step 407, the notification may be displayed by the processor of the device after receipt of the virtual card number and dynamic security code from the processor of the card. In some examples, the notification may be displayed for only a period of time and/or based on whether the user has been logged into an account for a period of time and/or whether the user has been engaged in an active session after logging into the account. The virtual card number and dynamic security code may be stored in a memory of the device.

FIG. 4B depicts a sequence diagram 410 of a process for authentication according to an exemplary embodiment. FIG. 4B may reference the same or similar components of system 100, first device 200 of FIG. 2A and FIG. 2B, method 300 of FIG. 3, and the sequence diagram 400 of FIG. 4A.

At step 411, a processor may be configured to request authentication. The processor may belong to a first device, including but not limited to a card (or other first device), a server, or a client device, or a combination thereof. In some examples, the processor may be configured to transmit an authentication request to any device, including but not limited to an application of a client device. In some examples, the request may be transmitted from a processor of a server to a processor or application of an intermediary device, such as a client device, which in turn may be configured to transmit the authentication request to the processor of the card and/or conduct a read of the card.

At step 412, the processor or application of the client device may be configured to conduct one or more reads. For example, the processor or application of the client device may be configured to conduct a read, such as a near field communication read, of a tag of the card to obtain read data. Other information that can be read and included in the read data include a unique identification number associated with the card, a counter (e.g. a counter associated with a number of reads of the first device, a counter associated with the number of transactions involving the first device, an application transaction counter), a PAN sequence number, a shared secret, and a cryptogram. In some examples, a cryptogram can be generated by the card that includes the read data, and the cryptogram can be generating using the read data and/or one or more cryptographic algorithms. In some examples, the shared secret can comprise a number that is known or derived by the application and/or server and stored on the card. The shared secret can be used in generating a cryptogram and/or performing cryptographic operations using one or more cryptographic algorithms. In some examples, the processor or application of the client device may be configured to display a notification or otherwise prompt to conduct the read.

For example, the processor or application of the client device may be configured to transmit, after entry into one or more communication fields of any device, data responsive to the read, such as a first read. For example, the processor may be configured to transmit, after a first entry into a first communication field of a device, the cryptogram. Without limitation, each entry may be associated with a tap, a swipe, a wave, and/or any combination thereof. The cryptogram may be received, upon request, via a near field communication data exchange format (NDEF) read. The processor or application may be configured to transmit the cryptogram. In some examples, the processor may be configured to encrypt the first cryptogram prior to its transmission. For example, the processor or application may be configured to generate a plurality of session keys, such as a first session key and a second session key, using secret keys combined with the counter. The MAC may be generated with the first session key. The MAC may be encrypted with the second session key prior to its transmission for decryption and validation.

At step 413, the processor or application of the client device can be configured to transmit the read data and a request for a virtual card number to the processor of a server. The processor of the server can be configured to receive the read data and request for virtual card number and, if necessary, decrypt the read data and request for virtual card number by any manner described herein. For example, the server may be configured to generate unique derived keys using the unique identifier and master keys. The server may be configured to generate session keys from the unique derived keys and the counter. The server may be configured to decrypt the encrypted MAC from the cryptogram.

At step 414, the processor of the server can be configured to authenticate the read data. For example, the server may be configured to validate the MAC using the session key.

At step 415, the processor of the server may be configured to generate a virtual card number and a dynamic security code based on mapping with a plurality of parameters of the read data, including, for example, a cryptogram including at least one selected from the group of a unique identifier, a counter, a session key, and a PAN sequence number. In some examples, an initial value of the virtual card number is zero. Without limitation, the virtual card number may include a total of up to 16 digits. Also without limitation, the dynamic security code may comprise a card verification value. For example, the card verification value may comprise a total of up to 3 digits. In other examples, an initial value of the virtual card number is non-zero.

At step 416, the processor the server may be configured to register the virtual card number with one or more payment authorization systems to enable use of the virtual number. In some examples, the processor may be further configured to restrict the virtual card number to a time window. For example, the processor may be configured to limit the use of the virtual card number to between a time window range including a first value and a second value. In some examples, the processor may be configured to restrict the dynamic security code for utilization in a time window. Further, the processor may be configured to invalidate the dynamic security code if not utilized within the time window. Without limitation, the time window range may include any number of seconds, minutes, hours, days, weeks, months, years, or the like. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

At step 417, the processor of the server may be configured to transmit the virtual card number and the dynamic security code to complete the authentication request. In some examples, the processor may be configured to transmit the virtual card number and the dynamic security code via a notification. Without limitation, the notification may include at least one selected from the group of a pop-up notification, a short message service, and a QR code.

The notification may be displayed by the processor or application of the client device after receipt of the virtual card number and dynamic security code from the processor of the server. In some examples, the notification may be displayed for only a period of time and/or based on whether the user has been logged into an account for a period of time and/or whether the user has been engaged in an active session after logging into the account. The virtual card number and dynamic security code may be stored in a memory of the client device.

FIG. 4C depicts a sequence diagram 420 of a process for authentication according to an exemplary embodiment. FIG. 4C may reference the same or similar components of system 100, first device 200 of FIG. 2A and FIG. 2B, method 300 of FIG. 3, the sequence diagram 400 of FIG. 4A, and the sequence diagram 410 of FIG. 4B.

At step 421, a processor may be configured to request authentication and a virtual card number. The processor may belong to a first device, including but not limited to a card (or other first device), a server, or a client device, or a combination thereof. In some examples, the processor may be configured to transmit an authentication request and request for a virtual card number to any device, including but not limited to an application of a client device and the processor of the card. In some examples, the requests may be transmitted from a processor of a server to a processor or application of an intermediary device, such as a client device, which in turn may be configured to transmit the authentication request to the processor of the card and/or conduct a read of the card.

At step 422, the processor of the card may be configured to generate a virtual card number and a dynamic security code based on mapping with a plurality of parameters of the read data, including, for example, a cryptogram including at least one selected from the group of a unique identifier, a counter, a session key, and a PAN sequence number. In some examples, an initial value of the virtual card number is zero. Without limitation, the virtual card number may include a total of up to 16 digits. Also without limitation, the dynamic security code may comprise a card verification value. For example, the card verification value may comprise a total of up to 3 digits. In other examples, an initial value of the virtual card number is non-zero.

In some examples, the processor may be further configured to restrict the virtual card number to a time window. For example, the processor may be configured to limit the use of the virtual card number to between a time window range including a first value and a second value. In some examples, the processor may be configured to restrict the dynamic security code for utilization in a time window. Further, the processor may be configured to invalidate the dynamic security code if not utilized within the time window. Without limitation, the time window range may include any number of seconds, minutes, hours, days, weeks, months, years, or the like. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

At step 423, the processor of the card may be configured to transmit the virtual card number and dynamic security code to the server. In some examples, the virtual card number and dynamic security code may be transmitted from the processor of the card to a processor or application of an intermediary device, such as a client device, which in turn may be configured to transmit the virtual card number and the dynamic security code to the processor of the server.

In some examples, prior to transmission, a cryptogram can be generated by the card that includes the virtual card number, dynamic security, and other data, including a unique identification number associated with the card, a counter (e.g. a counter associated with a number of reads of the first device, a counter associated with the number of transactions involving the first device, an application transaction counter, a PAN sequence number), a shared secret, and a cryptogram, using the included data and/or one or more cryptographic algorithms. In some examples, the shared secret can comprise a number that is known or derived by the application and/or server and stored on the card. The shared secret can be used in generating a cryptogram and/or performing cryptographic operations using one or more cryptographic algorithms.

In some examples, the processor of the card may be configured to encrypt the first cryptogram prior to its transmission. For example, the processor may be configured to generate a plurality of session keys, such as a first session key and a second session key, using secret keys combined with the counter. The MAC may be generated with the first session key. The MAC may be encrypted with the second session key prior to its transmission for decryption and validation.

The processor of the server can be configured to receive the read data and request for virtual card number and, if necessary, decrypt the read data and request for virtual card number by any manner described herein. For example, the server may be configured to generate unique derived keys using the unique identifier and master keys. The server may be configured to generate session keys from the unique derived keys and the counter. The server may be configured to decrypt the encrypted MAC from the cryptogram.

At step 424, the processor of the server can be configured to authenticate the read data. For example, the server may be configured to validate the MAC using the session key.

At step 425, the processor the server may be configured to register the virtual card number with one or more payment authorization systems to enable use of the virtual number. In some examples, the processor may be further configured to restrict the virtual card number to a time window. For example, the processor may be configured to limit the use of the virtual card number to between a time window range including a first value and a second value. In some examples, the processor may be configured to restrict the dynamic security code for utilization in a time window. Further, the processor may be configured to invalidate the dynamic security code if not utilized within the time window. Without limitation, the time window range may include any number of seconds, minutes, hours, days, weeks, months, years, or the like. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

At step 426, the processor of the server may be configured to transmit the virtual card number and the dynamic security code to complete the authentication request. In some examples, the processor may be configured to transmit the virtual card number and the dynamic security code via a notification. Without limitation, the notification may include at least one selected from the group of a pop-up notification, a short message service, and a QR code.

The notification may be displayed by the processor or application of the client device after receipt of the virtual card number and dynamic security code from the processor of the server. In some examples, the notification may be displayed for only a period of time and/or based on whether the user has been logged into an account for a period of time and/or whether the user has been engaged in an active session after logging into the account. The virtual card number and dynamic security code may be stored in a memory of the client device.

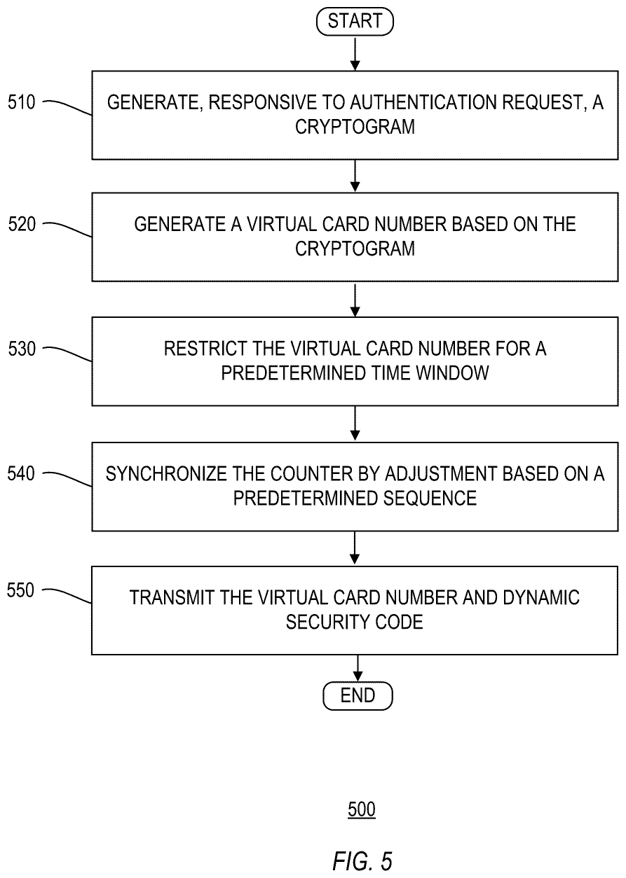

FIG. 5 depicts a method of 500 of authentication according to an exemplary embodiment. FIG. 5 may reference the same or similar components of system 100, first device 200 of FIG. 2A and FIG. 2B, method 300 of FIG. 3, the sequence diagram 400 of FIG. 4A, the sequence diagram 410 of FIG. 4B, and the sequence diagram 420 of FIG. 4C.

At block 510, the method may include generating, responsive to an authentication request, a cryptogram. For example, a processor may be configured to generated, responsive to an authentication request from an intermediary device or any other device, a cryptogram. The processor may belong to a first device, including but not limited to a card. In some examples, the processor may be configured to receive an authentication request from any device, including but not limited to a mobile device. The processor may be configured to transmit, after entry into one or more communication fields of any device, data responsive to the read, such as a first read. For example, the processor may be configured to transmit, after a first entry into a first communication field of a device, the cryptogram. Without limitation, each entry may be associated with a tap, a swipe, a wave, and/or any combination thereof. The cryptogram may be received, upon request, via a near field communication data exchange format (NDEF) read. The processor may be configured to transmit the cryptogram. In some examples, the processor may be configured to encrypt the first cryptogram prior to its transmission. For example, the processor may be configured to generate a plurality of session keys, such as a first session key and a second session key, using secret keys combined with the counter. The MAC may be generated with the first session key. The MAC may be encrypted with the second session key prior to its transmission for decryption and validation. The server may be configured to generate unique derived keys using the unique identifier and master keys. The server may be configured to generate session keys from the unique derived keys and the counter. The server may be configured to decrypt the encrypted MAC from the cryptogram. The server may be configured to validate the MAC using the session key.

The processor may be configured to transmit the cryptogram via the communication interface. For example, the processor may be configured to transmit the cryptogram to one or more applications. In some examples, the processor may be configured to transmit the cryptogram to an application comprising instructions for execution on a second device. The processor may be configured to update the counter value after transmission of the cryptogram.

In some examples, a server may be configured to receive the cryptogram transmitted by the processor. The application of the client device may be configured to transmit the cryptogram by the processor to the server. The server may be configured to decrypt the cryptogram.

At block 520, the method 300 may include generating, by the processor, a virtual card number and a dynamic security code based on mapping with a plurality of parameters of a cryptogram including at least one selected from the group of a unique identifier, a counter, a session key, and a PAN sequence number. In some examples, an initial value of the virtual card number is zero. Without limitation, the virtual card number may include a total of up to 16 digits. Also without limitation, the dynamic security code may comprise a card verification value. For example, the card verification value may comprise a total of up to 3 digits. In other examples, an initial value of the virtual card number is non-zero.

In other examples, the processor may receive the virtual card number generated by another device, such as a card, a server, or a client device. The virtual card number may be generated based on information received from the card (e.g., a unique identifier, a counter, and a shared secret) and upon successful authentication of the received information. The virtual card number can be generated with an initial or default security code value, such as a security code of zero. The virtual card number can be maintained in database of virtual card numbers and transmitted to the processor. The virtual card number can be encrypted by, e.g., a session key, prior to transmission. Upon receipt of the virtual card number, the processor can decrypt the virtual card number and generate the dynamic security code.

In some examples, the method may include restricting the virtual card number to a limited use. For example, the processor may be configured to limited the virtual card to a single use or any number of uses not to exceed a threshold number. Further, the processor may be configured to restrict the virtual card number to a limited use for, or to exclude, a type of transaction, a particular merchant, a category of merchant, and/or a transaction at or near a particular location. Without limitation, the processor may be configured to determine the restriction based on evaluation of transaction history information, transaction frequency over a given time period, transaction location, transaction amount, login information, session information, merchant information, and/or user account information.

In some examples, the processor may be configured to select, via one or more cryptographic algorithms, one or more digits of the cryptogram to generate the virtual card number. For example, the processor may be configured to select the first digit of the cryptogram. In another example, the processor may be configured to select the last digit of the cryptogram. In another example, the processor may be configured to select any number(s) and/or any sequence of number(s) between the first digit and the last digit of the cryptogram. In another example, the processor may be configured to select any combination of digits of the cryptogram.

In some examples, another device, such as a card, a server, or a client device, may be configured to select one or more digits of the cryptogram to generate the virtual card number. The virtual card number may be generated after a successful validation of the cryptogram and/or customer data (e.g., a customer identifier, transaction data). The virtual card number can be transmitted to the processor.

At block 530, the method may include restricting, by the processor, the virtual card number to a time window. For example, the processor may be configured to limit the use of the virtual card number to between a time window range including a first value and a second value. In some examples, the processor may be configured to restrict the dynamic security code for utilization in a time window. Further, the processor may be configured to invalidate the dynamic security code if not utilized within the time window. Without limitation, the time window range may include any number of seconds, minutes, hours, days, weeks, months, years, or the like.

Accordingly, when a user is prompted to input, including but not limited to via a mobile application for providing information to a website to process a transaction, the virtual card number and dynamic security code, the card may enter the communication field of the device to transmit this information with the cryptogram to the device. In this manner, the application of the device may be configured to transmit the cryptogram including the counter to the server. The server may be configured to permit the dynamic security code and virtual card number for the designated time window until the counter is adjusted. Thus, this implementation enables restricted use of the virtual card number and that requires the physical card itself and the dynamic security code.

At block 540, the method may include synchronizing, by the processor, the counter with the server during the time window. For example, the processor may be configured to adjust the counter. In some examples, the processor may be configured to increment the counter with the virtual card number and the dynamic security code during the time window. In other examples, the processor may be configured to decrement the counter with the virtual card number and the dynamic security code during the time window. The increment and/or decrement may be determined by the processor according to a sequence. For example, the processor may be configured to increment the counter by even numbers, odd numbers, or a formula so as to provide increased security and prevent the likelihood of brute force attacks. For example, the processor may be configured to decrement the counter by even numbers, odd numbers, or a formula so as to provide increased security and prevent the likelihood of brute force attacks. It is further understood that the sequence may be selected by the processor so as to avoid increased processing load on the card. In this manner, the one or more cryptographic algorithms may be configured to create a sufficiently high entropy number for the dynamic security code that may be reduce the likelihood of brute force attacks. The server may thus be configured to make a note of the adjusted, such as increment or decrement, counter of the card so as to associate it with the dynamic security code and virtual card number and also avoid asynchronization with the card. Absent the entry by the card into the communication field, such as the aforementioned tap, swipe, or wave, the dynamic security code and virtual card number generated by the card will not be able to be transmitted, and therefore result in non-compliance of the authentication request.

At block 550, the method may include transmitting, by the processor, the virtual card number and the dynamic security code to complete the authentication request. For example, the processor may be configured to transmit the virtual card number and the dynamic security code to complete the authentication request. For example, the processor may be configured to transmit, in response to a scan of a QR code, the virtual card number and the dynamic security code. In some examples, the processor may be configured to transmit the virtual card number and the dynamic security code via a notification. Without limitation, the notification may include at least one selected from the group of a pop-up notification, a short message service, and a QR code. The notification may be displayed by the device.

In some aspects, the techniques described herein relate to an authentication system, including: a processor; and a memory, the memory containing a unique identifier, a counter, a session key, and a sequence number, wherein the processor is configured to: receive an authentication request, receive a cryptogram including one or more parameters, the one or more parameters including at least one selected from the group of the unique identifier, the counter, the session key, and the sequence number, generate, in response to the authentication request, a virtual card number and a dynamic security code based on a mapping with the one or more parameters, and transmit the virtual card number and the dynamic security code to complete the authentication request.

In some aspects, the techniques described herein relate to an authentication system, wherein an initial value of the virtual card number is zero.

In some aspects, the techniques described herein relate to an authentication system, wherein the processor is further configured to limit the virtual card number to a single use for a type of transaction.

In some aspects, the techniques described herein relate to an authentication system, wherein the processor is further configured to select, via one or more cryptographic algorithms, one or more digits of the cryptogram to generate the virtual card number.

In some aspects, the techniques described herein relate to an authentication system, wherein the processor is further configured to restrict the virtual card number to a time window.

In some aspects, the techniques described herein relate to an authentication system, wherein the processor is further configured to synchronize the counter during the time window.

In some aspects, the techniques described herein relate to an authentication system, wherein the processor is further configured to increment the counter with the virtual card number and the dynamic security code during the time window.

In some aspects, the techniques described herein relate to an authentication system, wherein the processor is further configured to decrement the counter with the virtual card number and the dynamic security code during the time window.

In some aspects, the techniques described herein relate to an authentication system, wherein the processor is further configured to: restrict the dynamic security code for utilization in a time window, and invalidate the dynamic security code if not utilized within the time window.

In some aspects, the techniques described herein relate to an authentication system, wherein the processor is further configured to transmit, in response to a scan of a QR code, the virtual card number and the dynamic security code.

In some aspects, the techniques described herein relate to a method of authentication, including: receiving, by a processor, an authentication request; receiving, by the processor, a cryptogram including one or more parameters, the one or more parameters including at least one selected from the group of a unique identifier, a counter, a session key, and a sequence number; generating, by the processor in response to the authentication request, a virtual card number and a dynamic security code based on a mapping with the one or more parameters; and transmitting, by the processor, the virtual card number and the dynamic security code to complete the authentication request.

In some aspects, the techniques described herein relate to a method, wherein an initial value of the virtual card number is zero.

In some aspects, the techniques described herein relate to a method, further including limiting, by the processor, the virtual card number to a single use for a type of transaction.

In some aspects, the techniques described herein relate to a method, further including selecting, by the processor via one or more cryptographic algorithms, one or more digits of the cryptogram to generate the virtual card number.

In some aspects, the techniques described herein relate to a method, further including restricting, by the processor, the virtual card number to a time window.

In some aspects, the techniques described herein relate to a method, further including synchronizing, by the processor, the counter during the time window.

In some aspects, the techniques described herein relate to a method, further including incrementing, by the processor, the counter with the virtual card number and the dynamic security code during the time window.

In some aspects, the techniques described herein relate to a method, further including decrementing, by the processor, the counter with the virtual card number and the dynamic security code during the time window.

In some aspects, the techniques described herein relate to a method, further including transmitting, by the processor, the virtual card number and the dynamic security code via a notification, the notification including at least one selected from the group of a pop-up notification, a short message service, and a QR code.

In some aspects, the techniques described herein relate to a computer accessible non-transitory medium including computer executable instructions that, when executed on a processor, perform procedures including the steps of: receiving an authentication request; receiving a cryptogram including one or more parameters, the one or more parameters including at least one selected from the group of a unique identifier, a counter, a session key, and a sequence number; generating, in response to the authentication request, a virtual card number and a dynamic security code based on a mapping with the one or more parameters; and transmitting the virtual card number and the dynamic security code to complete the authentication request.

Throughout the present disclosure, reference is made to a card, such as a contact-based card and a contactless card. It is understood that the present disclosure is not limited to a particular type of card, and instead this disclosure encompasses a contact-based card, a contactless card, or any other card. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. An authentication system, comprising:
a processor; and
a memory, the memory containing a unique identifier, a counter, a session key, and a sequence number,
wherein the processor is configured to:
receive an authentication request,
receive a cryptogram including one or more parameters, the one or more parameters comprising at least one selected from the group of the unique identifier, the counter, the session key, and the sequence number,
generate, in response to the authentication request, a virtual card number and a dynamic security code based on a mapping with the one or more parameters, and
transmit the virtual card number and the dynamic security code to complete the authentication request.

2. The authentication system of claim 1, wherein an initial value of the virtual card number is zero.

3. The authentication system of claim 1, wherein the processor is further configured to limit the virtual card number to a single use for a type of transaction.

4. The authentication system of claim 1, wherein the processor is further configured to select, via one or more cryptographic algorithms, one or more digits of the cryptogram to generate the virtual card number.

5. The authentication system of claim 1, wherein the processor is further configured to restrict the virtual card number to a time window.

6. The authentication system of claim 5, wherein the processor is further configured to synchronize the counter during the time window.

7. The authentication system of claim 6, wherein the processor is further configured to increment the counter with the virtual card number and the dynamic security code during the time window.

8. The authentication system of claim 6, wherein the processor is further configured to decrement the counter with the virtual card number and the dynamic security code during the time window.

9. The authentication system of claim 1, wherein the processor is further configured to:
restrict the dynamic security code for utilization in a time window, and
invalidate the dynamic security code if not utilized within the time window.

10. The authentication system of claim 1, wherein the processor is further configured to transmit, in response to a scan of a QR code, the virtual card number and the dynamic security code.

11. A method of authentication, comprising:
receiving, by a processor, an authentication request;
receiving, by the processor, a cryptogram including one or more parameters, the one or more parameters comprising at least one selected from the group of a unique identifier, a counter, a session key, and a sequence number;
generating, by the processor in response to the authentication request, a virtual card number and a dynamic security code based on a mapping with the one or more parameters; and
transmitting, by the processor, the virtual card number and the dynamic security code to complete the authentication request.

12. The method of claim 11, wherein an initial value of the virtual card number is zero.

13. The method of claim 11, further comprising limiting, by the processor, the virtual card number to a single use for a type of transaction.

14. The method of claim 11, further comprising selecting, by the processor via one or more cryptographic algorithms, one or more digits of the cryptogram to generate the virtual card number.

15. The method of claim 11, further comprising restricting, by the processor, the virtual card number to a time window.

16. The method of claim 15, further comprising synchronizing, by the processor, the counter during the time window.

17. The method of claim 16, further comprising incrementing, by the processor, the counter with the virtual card number and the dynamic security code during the time window.

18. The method of claim 16, further comprising decrementing, by the processor, the counter with the virtual card number and the dynamic security code during the time window.

19. The method of claim 11, further comprising transmitting, by the processor, the virtual card number and the dynamic security code via a notification, the notification including at least one selected from the group of a pop-up notification, a short message service, and a QR code.

20. A computer accessible non-transitory medium comprising computer executable instructions that, when executed on a processor, perform procedures comprising the steps of:
receiving an authentication request;
receiving a cryptogram including one or more parameters, the one or more parameters comprising at least one selected from the group of a unique identifier, a counter, a session key, and a sequence number;
generating, in response to the authentication request, a virtual card number and a dynamic security code based on a mapping with the one or more parameters; and
transmitting the virtual card number and the dynamic security code to complete the authentication request.
